(19) United States
(12) Patent Application Publication
(10) Pub. No.: US 2016/0363716 A1
(43) Pub. Date: Dec. 15, 2016

(54) DISPLAY DEVICE

(71) Applicant: Samsung Display Co., Ltd., Yongin-si (KR)

(72) Inventor: Junwoo YOU, Seongnam-si (KR)

(21) Appl. No.: 15/007,311

(22) Filed: Jan. 27, 2016

(30) Foreign Application Priority Data
Jun. 15, 2015 (KR) 10-2015-0084132

(51) Int. Cl. F21V 8/00

(52) U.S. Cl. CPC G02B 6/0068; G02B 6/0083

(57) ABSTRACT

A display device includes: a display panel which display an image with light; a light source which generates and emits the light and includes a first light source and a second light source which are disposed at a same side of the display panel and each generate light; and a light guide plate which receives the light emitted from the light source and emits the light to the display panel. The light guide plate defines a light incident side surface thereof at the same side of the display panel at which the first and second light sources are disposed. The light incident side surface includes a first inclination surface facing the first light source and a second inclination surface facing the second light source.

This application claims priority to Korean Patent Application No. 10-2015-0084132, filed on Jun. 15, 2015, and all the benefits accruing therefrom under 35 U.S.C. §119, the contents of which in their entirety are herein incorporated by reference.

### BACKGROUND

1. Field

Exemplary embodiments of the invention relate to a display device, and more particularly, to a display device providing light having uniform brightness and color.

2. Description of the Related Art

A liquid crystal display (“LCD”) device is a type among flat panel display (“FPD”) devices that have gained wide acceptance. An LCD device includes a liquid crystal display panel including two display substrates having electrodes formed therein and a liquid crystal layer interposed between the two display substrates. In such an LCD device, orientations of liquid crystal molecules of the liquid crystal layer are rearranged by voltages that are applied to the electrodes, thereby adjusting the amount of light transmitted therethrough and displaying an image on the LCD device.

Due to being a non-emissive element, the liquid crystal display panel included in an LCD device utilizes a backlight assembly generating and providing light to the liquid crystal display panel. The backlight assembly is classified into an edge-type backlight assembly and a direct-type backlight assembly based on a position of a light source within the backlight unit. The edge-type backlight unit has a structure in which a light source is disposed at a side surface of a light guide plate.

The light source may be a cold cathode fluorescent lamp (“CCFL”) or a light emitting diode (“LED”) package. Among various types of light sources, the LED package is garnering attention as a substitute for the CCFL, due to having relatively low power consumption and relatively high luminance.

### SUMMARY

One or more exemplary embodiments of the invention are directed to a display device providing light having uniform brightness and color.

According to an exemplary embodiment of the invention, a display device includes: a display panel which displays an image with light; a light source which generates and emits the light, the light source including a first light source and a second light source which are disposed at a same side of the display panel and each generate the light; and a light guide plate which receives the light emitted from the light source and emits the light to the display panel. The light guide plate defines a light incident side surface thereof at the same side of the display panel at which the first and second light sources are disposed. The light incident side surface includes a first inclination surface facing the first light source and a second inclination surface facing the second light source.

An angle formed between the first inclination surface and the second inclination surface may be an acute angle.

The display device may further include a circuit board at the light incident side surface of the light guide plate, the circuit board defining a first inclination portion thereof on which the first light source is mounted and a second inclination portion thereof on which the second light source is mounted.

A wavelength of the light emitted by the first light source may be different from a wavelength of the light emitted from the second light source.

The light guide plate may further include: a base portion thereof extended to define a light mixing portion of the light guide plate at which are mixed the light emitted from the first light source and the light emitted from the second light source to thereby generate white light. The light mixing portion may include the first and second inclination surfaces.

The light mixing portion may be disposed in a non-display area of the display panel.

The base portion of the light guide plate may define a light emitting surface thereof facing the display panel and through which the light is emitted to the display panel. An upper surface of the light mixing portion may have be spaced apart from the light emitting surface in a thickness direction of the light guide plate.

The light source may further include a third light source which generates and emits the light at the same side of the display panel at which the first and second light sources are disposed, and the light incident side surface defined by the light guide plate may further include a third inclination surface facing the third light source.

An angle formed between the first inclination surface and the third inclination surface may be an obtuse angle, and an angle formed between the second inclination surface and the third inclination surface may be an obtuse angle.

A wavelength of light emitting from the third light source may be different from a wavelength of the light emitted from the first light source and different from a wavelength of the light emitted from the second light source. The light guide plate may further define: a base portion thereof extended to define a light mixing portion of the light guide plate at which are mixed the light emitted from the first light source, the light emitted from the second light source, and the light emitted from the third light source to thereby generate white light.

According to an exemplary embodiment of the invention, a display device includes: a display panel which displays an image with light; a light source which generates and emits the light, the light source including a first light source and a second light source which are disposed at a same side of the display panel and each generate the light, the first light source and the second light source being alternately disposed along a length of the same side of the display panel; and a light guide plate which receives the light emitted from the light source. The light guide plate defines a light incident side surface thereof at the same side of the display panel at which the first and second light sources are disposed, and the light incident surfaces includes a first inclination surface facing the light source and a second inclination surface facing the light source.

An angle formed between the first inclination surface and the second inclination surface may be an acute angle.

The display device may further include a circuit board at the light incident side surface of the light guide plate. The circuit board may define a first inclination portion thereof on which a portion of the light sources are mounted and a second inclination portion thereof on which a remaining portion of the first and second light sources are mounted.

A wavelength of the light emitted from the first light source may be different from a wavelength of the light emitted from the second light source.

The light guide plate may further define: a base portion thereof extended to define a light mixing portion of the light guide plate at which are mixed the light emitted from the first light source and the light emitted from the second light source to thereby generate white light. The light mixing portion includes the first and second inclination surfaces.

The light mixing portion may be disposed in a non-display area of the display panel.

The base portion of the light guide plate may define a light emitting surface thereof facing the display panel and through which the light is emitting to the display panel. An upper surface of the light mixing portion may be spaced apart from the light emitting surface in a thickness direction of the light guide plate.

The light source may further include a third light source which generates and emits the light at the same side of the display panel at which the first and second light sources are disposed. The incident side surface defined by the light guide plate may include a third inclination surface facing the third light source.

An angle formed between the first inclination surface and the third inclination surface may be an obtuse angle, and an angle formed between the second inclination surface and the third inclination surface may be an obtuse angle.

A wavelength of the light emitted from the third light source may be different from a wavelength of the light emitted from the first light source and different from a wavelength of the light emitted from the second light source. The light guide plate may further define: a base portion thereof extended to define a light mixing portion of the light guide plate at which are mixed the light emitted from the first light source, the light emitted from the second light source, and the light emitted from the third light source to thereby generate white light.

The foregoing is illustrative only and is not intended to be in any way limiting. In addition to the illustrative embodiments, and features described above, further embodiments, and features will become apparent by reference to the drawings and the following detailed description.

### BRIEF DESCRIPTION OF THE DRAWINGS

The above and other features of the present disclosure of invention will be more clearly understood from the following detailed description taken in conjunction with the accompanying drawings, in which:

FIG. 1 is an exploded perspective view illustrating an exemplary embodiment of a display device according to the invention;

FIG. 2 is a cross-sectional view taken along line A-A′ of FIG. 1;

FIG. 3 is a cross-sectional view illustrating color mixing occurring at a light mixing portion of an exemplary embodiment of a light guide plate in the display device of FIG. 1;

FIG. 4A is a perspective view and FIGS. 4B and 4C are cross-sectional views illustrating an exemplary embodiment of a light source unit in the display device of FIG. 1;

FIG. 4D is a perspective view illustrating an exemplary embodiment of a light guide plate in the display device of FIG. 1;

FIG. 5 is a perspective view illustrating another exemplary embodiment of a light source unit of a display device according to the invention;

FIG. 6 is a cross-sectional view illustrating another exemplary embodiment of a display device according to the invention;

FIG. 7 is a cross-sectional view illustrating still another exemplary embodiment of a display device according to the invention;

FIG. 8 is a cross-sectional view illustrating yet another exemplary embodiment of a display device according to the invention;

FIG. 9 is an exploded perspective view illustrating yet another exemplary embodiment of a display device according to the invention; and

FIG. 10 is a cross-sectional view taken along line D-D′ of FIG. 9.

### DETAILED DESCRIPTION

Advantages and features of the invention and methods for achieving them will be made clear from exemplary embodiments described below in detail with reference to the accompanying drawings. The invention may, however, be embodied in many different forms and should not be construed as being limited to the exemplary embodiments set forth herein. Rather, these exemplary embodiments are provided so that this disclosure will be thorough and complete, and will fully convey the scope of the invention to those skilled in the art. The invention is merely defined by the scope of the claims. Therefore, well-known constituent elements, operations and techniques are not described in detail in the exemplary embodiments in order to prevent the invention from being obscurely interpreted. Like reference numerals refer to like elements throughout the specification.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The spatially relative terms “below,” “beneath,” “lower,” “above,” “upper,” and the like, may be used herein for ease of description to describe the relations between one element or component and another element or component as illustrated in the drawings. It will be understood that the spatially relative terms are intended to encompass different orientations of the device in use or operation, in addition to the orientation depicted in the drawings. For example, in the case where a device shown in the drawing is turned over, the device positioned “below” or “beneath” another device may be placed “above” another device. Accordingly, the illustrative term “below” may include both the lower and upper positions. The device may also be oriented in the other direction, and thus the spatially relative terms may be interpreted differently depending on the orientations.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms used herein (including technical and scientific terms) have the same meaning as commonly understood by those skilled in the art. It will be further understood that terms, such as those defined in commonly used dictionaries, should be interpreted as having a meaning that is consistent with their meaning in the context of the relevant art and will not be interpreted in an ideal or excessively formal sense unless clearly defined in the present specification.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

In a display device for which a backlight assembly thereof includes two types of light sources, such as two light emitting diode (“LED”) packages generating lights having different colors and a circuit board on which the two types of LED packages are mounted, and the different color lights generated from the two types of LED packages are mixed to generate a white light, the display quality of the display device may vary based on the arrangement of the two types of LED packages on the circuit board. For example, as an interval between the two types of LED packages increases, the effect of color mixing of the lights having different colors may be reduced such that a color stain may undesirably occur. In addition, in a display device for which where an LED package generating a light having a predetermined color is arranged corresponding to a corner portion of a display area of a display panel, a dark spot may undesirably occur in the corner portion.

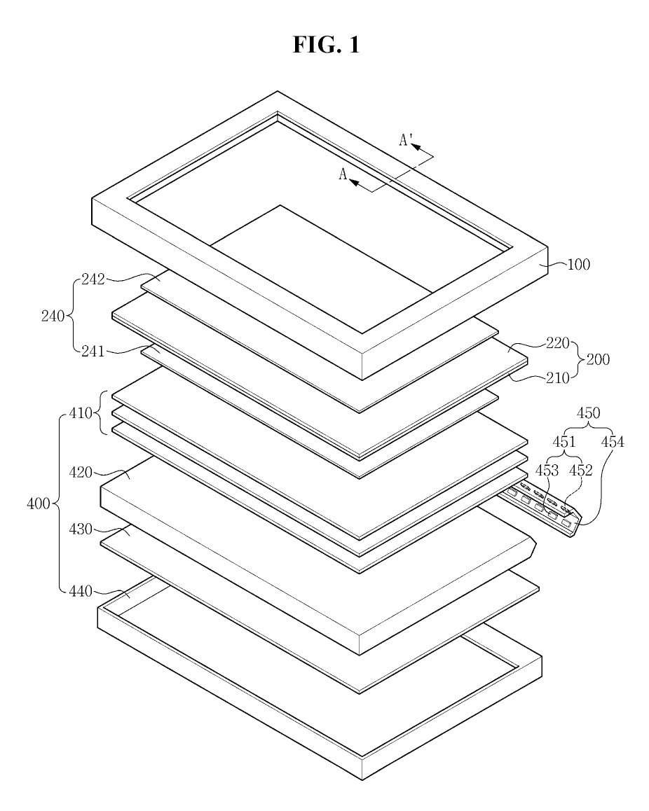

Hereinafter, an exemplary embodiment of a display device will be described with reference to FIGS. 1, 2, 3, 4A, 4B, 4C and 4D.

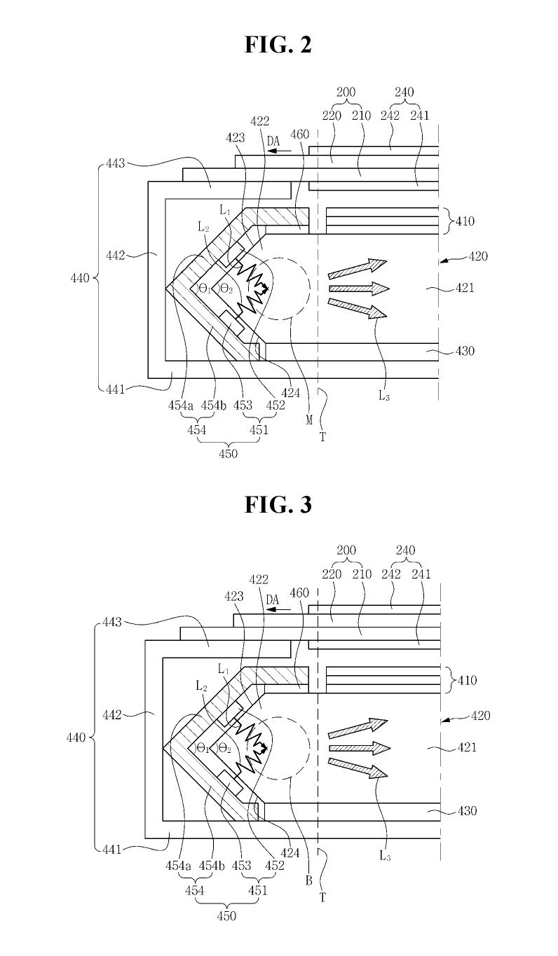

FIG. 1 is an exploded perspective view illustrating an exemplary embodiment of a display device according to the invention. FIG. 2 is a cross-sectional view taken along line A-A′ of FIG. 1.

Referring to FIGS. 1 and 2, the display device includes a display panel 200 which displays an image, a backlight assembly 400 which generates and provides light to the display panel 200, and an upper frame 100 which surrounds the display panel 200.

The upper frame 100 is coupled to a lower frame 440 of the backlight assembly 400 so as to cover a portion of the display panel 200 that is mounted on the lower frame 440. The upper frame 100 includes a side surface portion 110 which is coupled to the lower frame 440, and an upper surface portion 120 bent from the side surface portion 110 to extend therefrom. Portions of the upper frame 100 may define the side surface portion 110 thereof and the upper surface portion 120 thereof. An edge portion of the display panel 200 covered by the upper frame 100 is a non-display area of the display panel 200 and/or the overall display device. The upper frame 100 has an opening defined at a center portion thereof through which the display panel 200 is exposed.

The upper frame 100 may be coupled to the lower frame 440 through hook coupling and/or screw coupling. In addition, the coupling of the upper frame 100 and the lower frame 440 to each other may be modified in various manners. According to alternative exemplary embodiments, the upper frame 100 may be omitted from the display device based on the type of the display device.

The display panel 200 is configured to display images. The display panel 200 that is a light-receiving type (or non-emissive-type) display panel may include a liquid crystal display (“LCD”) panel, an electrowetting display panel, an electrophoretic display (“EPD”) panel, a microelectromechanical system (“MEMS”) display panel, and the like. The display panel 200 according to the first exemplary embodiment uses an LCD panel by way of example, but the invention is not limited thereto.

The display panel 200 may be provided in a quadrangular planar shape having two pairs of parallel sides in a top plan view. According to the exemplary embodiment, the display panel 200 may have a rectangular shape in the top plan view defined by a pair of relatively long sides and a pair of relatively short sides. The display panel 200 includes a first display substrate 210, a second display substrate 220 opposing the first display substrate 210, and a liquid crystal layer (not illustrated) between the first display substrate 210 and the second display substrate 220. The display panel 200, when viewed from the top plan view, includes a display area in which an image is displayed and the non-display area which surrounds the display area and in which an image is not displayed. The non-display area is covered by the upper frame 100.

The first display substrate 210 may include disposed therein a plurality of pixel electrodes (not illustrated) and a plurality of thin film transistors (not illustrated) which is electrically connected to the pixel electrodes in one-to-one correspondence. In the first display substrate 210, the thin film transistor includes a source electrode connected to a data line, a gate electrode connected to a gate line, and a drain electrode connected to the pixel electrode. In the first display substrate 210, each of the thin film transistors functions as a switch of a driving signal supplied to a corresponding one of the pixel electrodes. Further, the second display substrate 220 may include disposed therein a common electrode (not illustrated) forming an electric field which controls an alignment of liquid crystals, along with the pixel electrodes. The display panel 200 is configured to drive the liquid crystal layer to display an image frontwards of the display device.

The display panel 200 may further include a driving chip (not illustrated) configured to supply a driving signal, a driving chip mounting film (not illustrated) on which the driving chip is mounted, and a printed circuit board (“PCB”, not illustrated) electrically connected to the display panel 200 through the driving chip mounting film. The driving chip mounting film may be a tape carrier package (“TCP”).

The driving chip generates a driving signal for driving the display panel 200 in response to an external signal applied thereto. The external signal is supplied from the PCB, and may include an image signal, various control signals, a driving voltage, and the like.

A polarizer 240 is disposed on the display panel 200, and collectively includes a first polarizer 241 and a second polarizer 242. The first and second polarizers 241 and 242 are disposed on respective surfaces of the first display substrate 210 and the second display substrate 220 that are opposite to respective surfaces of the first display substrate 210 and the second display substrate 220 facing one another. In other words, the first polarizer 241 may be attached to an outer side of the first display substrate 210 and the second polarizer 242 may be attached to an outer side of the second display substrate 220. A transmissive axis of the first polarizer 241 is substantially perpendicular with respect to a transmissive axis of the second polarizer 242.

The backlight assembly 400 includes an optical sheet 410, a light guide plate 420, a reflective sheet 430, the lower frame 440 and a light source unit 450.

The light source unit 450 includes a light source 451 and a circuit board 454 on which the light source 451 is disposed. The light source unit 450 may be provided at an edge or a light-incident side surface of the light guide plate 420. In other words, the light source unit 450 may generate and emit light toward the edge or the light-incident side surface of the light guide plate 420.

The light source unit 450 may be provided on one, two or four side surfaces of the light guide plate 420 based on a size, luminance uniformity, and the like, of the display panel 200. According to an alternative exemplary embodiment, the light source unit 450 may be disposed at least at one of the edges of the light guide plate 420.

The light guide plate 420 defines a light emitting surface thereof, a rear surface thereof opposing the light emitting surface, and the four side surfaces thereof which connect the light emitting surface to the rear surface. The light guide plate 420 receives the light emitted from the light source 451 incident on the light-incident side surface thereof, and outputs the light toward a light-dissipating (e.g., light emitting) surface of the light guide plate 420 facing the display panel 200. The light guide plate 420 is configured to uniformly supply, to the display panel 200, the light supplied from the light source unit 450. The light guide plate 420 is disposed adjacent to the light source unit 450 and is accommodated in the lower frame 440. The light guide plate 420 may be provided, for example, in a quadrangular planar shape, similar to a shape of the display panel 200, but the shape of the light guide plate 420 is not limited thereto. According to an alternative exemplary embodiment in which an LED is used as the light source 451, the light guide plate 420 may have various shapes defined therein such as, for example, a predetermined groove and/or a protrusion, based on a position of the light source 451.

The light guide plate 420 is described herein as having a planar shape, that is, a plate such as having a relatively large cross-sectional thickness, for ease of description but is not limited thereto. According to an alternative exemplary embodiment, the light guide plate 420 may be provided in a sheet or film shape for which the cross-sectional thickness is smaller than that of the plate and is relatively small as compared to the planar size thereof to achieve slimness of the display device. The light guide plate 420 is to be understood as having a concept that includes not only a plate but also a film which guides light provided from the light source unit 450.

The light guide plate 420 may include a light-transmissive material. The light-transmissive material may include polycarbonate (“PC”), or an acrylic resin such as polymethyl methacrylate (“PMMA”) to help guide light efficiently.

A pattern may be disposed on or defined in at least a surface of the light guide plate 420. In an exemplary embodiment, for example, a scattering pattern (not illustrated) may be defined to allow light guided to a lower surface of the light guide plate 420 to be emitted upwardly thereof toward the display panel 200.

The optical sheet 410 is disposed on the light guide plate 420 and diffuses and/or collimates light transmitted from the light guide plate 420. The optical sheet 410 may collectively include a diffusion sheet, a prism sheet, a protective sheet, and the like.

The diffusion sheet may disperse light incident from the light guide plate 420 to thereby reduce or effectively prevent the light from being partially concentrated.

The prism sheet may include, on a surface thereof, prisms having a triangular cross-section and provided in a predetermined array. The prism sheet may be disposed on the diffusion sheet to collimate light diffused from the diffusion sheet in a direction perpendicular with respect to the display panel 200.

The protective sheet may be disposed on the prism sheet, may protect a surface of the prism sheet, and may diffuse light in order to achieve uniform light distribution.

The reflective sheet 430 is interposed between the light guide plate 420 and the lower frame 440, and reflects light that is emitted downwardly from the light guide plate 420 so as to allow the light to be re-directed toward the display panel 200, thereby improving light efficiency.

The reflective sheet 430 may include or be formed of, for example, polyethylene terephthalate (“PET”), thus having reflectivity. A surface of the reflective sheet 430 body may be coated with a diffusion layer containing, for example, titanium dioxide (TiO₂).

According to alternative exemplary embodiments, the reflective sheet 430 body may include or be formed of a material containing a metal, such as silver (Ag).

The lower frame 440 accommodates the reflective sheet 430 and the light guide plate 420 therein. The lower frame 440 includes a bottom portion 441, a side wall portion 442 extending bent from the bottom portion 441, and a panel supporting portion 443 extending bent from the side wall portion 442. Portions of the lower frame 440 define the bottom portion 441 thereof, the side wall portion 442 thereof and the panel supporting portion 443 thereof. The bottom portion 441 of the lower frame 440 is extended parallel to the light guide plate 420. The side wall portion 442 defines a thickness of an accommodating space of the lower frame 440. The panel supporting portion 443 extends from the side wall portion 442 to be substantially parallel to the bottom portion 441 of the lower frame 440, and supports the display panel 200 thereon. A fixing member 460 such as a double-sided tape may be disposed between the panel supporting portion 443 and the display panel 200 so as to fix the display panel 200 within the backlight assembly 400. The lower frame 440 may include or be formed of a metal material having relatively high rigidity such as stainless steel, or a material having a relatively high heat dissipation property such as aluminum (Al) or an Al alloy. The lower frame 440 according to the exemplary embodiment maintains an overall framework of the display device, and protects various components accommodated therein.

In the configuration of the backlight assembly 400 as described above, the light source unit 450 and the light guide plate 420 that provides white light having high color reproducibility will be described hereinbelow.

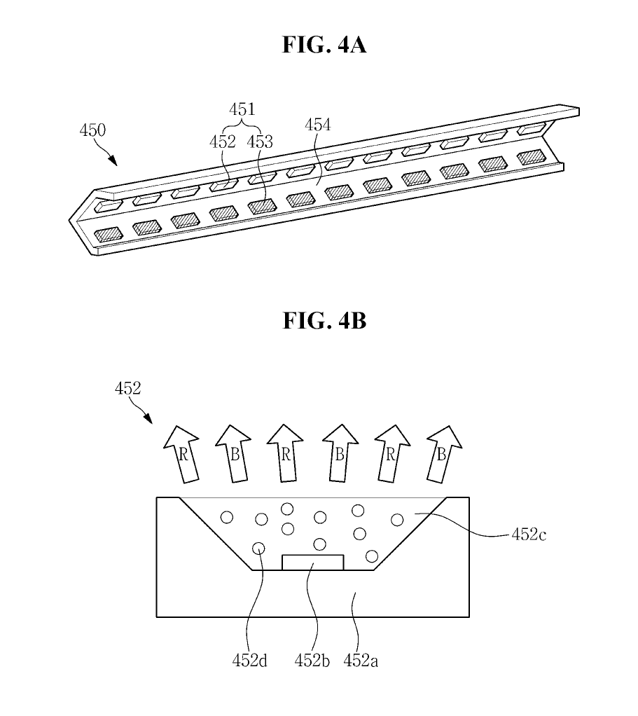

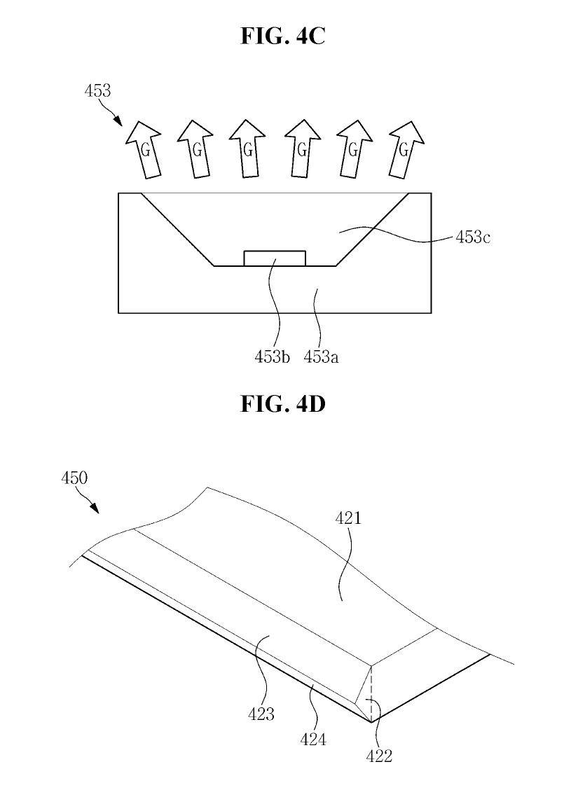

FIG. 3 is a cross-sectional view illustrating color mixing occurring at a light mixing portion 422 of the light guide plate 420 of FIG. 1. FIG. 4A is a perspective view and FIGS. 4B and 4C are cross-sectional views illustrating the light source unit 450 of FIGS. 1, and 4D is perspective view illustrating the light guide plate 420 of FIG. 1.

Referring to FIGS. 3, 4A, 4B, 4C and 4D, the light source 451 collectively includes a first light source 452 and a second light source 453. The first light source 452 emits a light having a different wavelength from a wavelength of a light emitted from the second light source 453. In an exemplary embodiment, for example, the first light source 452 emits a blue light B and a red light R, and the second light source 453 emits a green light G.

In detail, the first light source 452 includes a first mold 452a, a first light emitting element 452b, a first insulating layer 452c and a phosphor 452d.

The first mold 452a defines an accommodating space in which the first light emitting element 452b is accommodated, and defines an opening at an upper portion thereof. The first mold 452a may include or be formed of an insulating material. In an exemplary embodiment, for example, the first mold 452a may include plastic such as polyphthalamide (“PPA”).

The first light emitting element 452b is accommodated in the accommodating space of the first mold 452a, and emits a light having a wavelength in a range of about 400 nanometers (nm) to about 500 nm. The light having the wavelength in the range of about 400 nm to about 500 nm corresponds to a blue light B. While ultraviolet (“UV”) light generally has a wavelength of less than about 400 nm, the blue light B has the wavelength in the range of about 400 nm to about 500 nm. The first light emitting element 452b includes such as, for example, a light emitting diode (“LED”), a laser diode or a solid laser.

The first insulating layer 452c fills the accommodating space of the first mold 452a to cover the first light emitting element 452b. The first insulating layer 452c includes an insulating material, and the insulating material may include a light-transmissive material such as a silicon resin and an epoxy resin. Accordingly, the blue light B generated from the first light emitting element 452b may be transmitted through the first insulating layer 452c to be output externally from the first light source 452 and/or may be supplied to the phosphor 452d within the first insulating layer 452c.

The phosphor 452d may be provided in plural and dispersed within the first insulating layer 452c. The phosphors 452d receive a portion of the blue lights B emitted from the first light emitting element 452b and generate a light having a wavelength in a range of about 580 nm to about 670 nm which is different from the wavelength of the blue light B. The light having the wavelength in the range of about 580 nm to about 670 nm corresponds to the red light R. The phosphor 452d may be a red inorganic phosphor. In an exemplary embodiment, for example, the phosphor 452d includes at least one of a nitride-based red phosphor and a fluoride-based red phosphor. In detail, the red phosphor 452d includes at least one of (Sr, Ca)AlSiN3:Eu, (Sr, Ca)AlSi(ON)3:Eu, (Sr, Ca)2Si5N8:Eu, (Sr, Ca)2Si5(ON)8:Eu, and (Sr, Ba)SiAl4N7:Eu, which correspond to the nitride-based red phosphor. In addition, the phosphor 452d may include K2SiF6:Mn4+, which corresponds to the fluoride-based red phosphor.

As the first light source 452 is configured in the above-described manner, the first light source 452 emits a light collectively including the blue light B and the red light R to the light guide plate 420.

The second light source 453 includes a second mold 453a, a second light emitting element 453b and a second insulating layer 453c. The second mold 453a and the second insulating layer 453c have the same configurations as those of the first mold 452a and the first insulating layer 452c, respectively. The second light emitting element 453b is accommodated in an accommodating space defined by the second mold 453a, and emits a light having a wavelength in a range of about 500 nm to about 580 nm. The light having the wavelength in the range of about 500 nm to about 580 nm corresponds to a green light G. The second light emitting element 453b includes such as, for example, an LED, a laser diode or a solid laser.

As the second light source 453 is configured in the above-described manner, the second light source 453 collectively emits the green light G to the light guide plate 420.

Accordingly, all the red light R, the blue light B and the green light G are emitted from the first light source 452 and the second light 453.

The light guide plate 420 receives the light emitted from the first light source 452 and the second light source 453 and which is incident thereon. The light guide plate 420 includes a first inclination surface 423 facing the first light source 452 and a second inclination surface 424 facing the second light source 453. The first and second inclination surfaces 423 and 424 are inclined with respect to each other and are inclined at different angles with respect to the light emitting surface of the light guide plate 420. An internal angle θ2 formed between the first inclination surface 423 and the second inclination surface 424 is an acute angle. As used herein, the angle θ2 formed between the first inclination surface 423 and the second inclination surface 424 is referred to as an incident angle for ease of description.

For example, the light guide plate 420 includes a base portion 421, and the light mixing portion 422 which extends from the base portion 421 and in which a light L1 emitted from the first light source 452 and a light L2 emitted from the second light source 453 are mixed to generate a white light L3. Based on the dotted line T in FIG. 3, the portion of the light guide plate 420 to the left is the light mixing portion 422 thereof, and the portion of the light guide plate 420 to the right is the base portion 421 thereof. The light mixing portion 422 may be disposed in a non-display area DA of the display panel 200 and/or the display device. The mixing portion 422 is defined by first and second inclination surfaces 423 and 424 and horizontal surfaces respectively extending therefrom and connected directly to upper and lower horizontal surfaces of the base portion 421 which are coplanar with the horizontal surfaces of the mixing portion 422.

The light mixing portion 422 extends from a side surface of the base portion 421 of the light guide plate 420 that faces the light source unit 450, and defines the first inclination surface 423 and the second inclination surface 424. An extended portion of the base portion 421 may define the light mixing portion 422 of the light guide plate 420. Portions of the light guide plate 420 may further define the first inclination surface 423 thereof, the second inclination surface 423 thereof and the light mixing portion 422 thereof. The first inclination surface 423 and the second inclination surface 423 may define a whole of the light incident surface of the light guide plate 420.

The light L1 which is incident to and passes through the first inclination surface 423 of the light mixing portion 422 and the light L2 which is incident to and passes through the second inclination surface 424 of the light mixing portion 422 are mixed in a light overlapping area M of the light mixing portion 422, and the resulting mixed white light L3 is incident on the side surface of the base portion 421. In other words, the red light R and the blue light B incident from the first light source 452 and the green light G incident from the second light source 453 are mixed at the light overlapping area M to generate the white light L3.

With reference to the dotted line T as indicated in FIG. 3, as the incident angle θ2 defined by the light guide plate 420 increases, a length of the light mixing portion 422 taken from the side surface of the base portion 421 decreases, and the dotted line T moves rightwards. Accordingly, the display device may relatively easily achieve a narrow bezel. Conversely, as the incident angle θ2 of the light guide plate 420 decreases, the length of the light mixing portion 422 taken from the side surface of the base portion 421 increases, and the dotted line T moves leftwards. According to one or more exemplary embodiment, a space for mixing the light L1 emitted from the first light source 452 and the light L2 emitted from the second light source 453 may be expanded, such that a white light may be obtained relatively easily. In this regard, the size of the incident angle θ2 may be appropriately determined under conditions of achieving a narrow bezel and high color reproducibility.

The circuit board 454 is disposed at a side surface of the light guide plate 420. The circuit board 454 includes a first inclination portion 454a on which the first light source 452 is mounted and a second inclination portion 454b on which the second light source 453 is mounted. Portions of the circuit board 454 may define the first inclination portion 454a thereof and the second inclination portion 454b thereof. An internal angle θ1 formed between the first inclination portion 454a and the second inclination portion 454b is an acute angle. In an exemplary embodiment, for example, the angle θ1 formed between the first inclination portion 454a and the second inclination portion 454b may be substantially the same as or similar to the incident angle θ2 described above but is not limited thereto.

In FIG. 4A, along a length direction of the circuit board 454, each of the first light source 452 is provided in plural is disposed on the first inclination portion 454a while each of the second light source 453 provided in plural is disposed on the second inclination portion 454b, but the light source unit 450 is not limited thereto. Opposing ends of the length of the circuit board 454 may define opposing ends of the light source unit 450. The opposing ends of the light source unit 450 may respectively correspond to opposing corners of the display panel 200 and/or the display device.

As the light source 451 is disposed in the above-described manner, the luminance and color of light may be uniformly provided. In particular, a color stain and a dark spot may be reduced or effectively prevented at a corner of the display area of the display device. In other words, as a plurality of light sources displaying different colors are typically disposed in parallel to one another, a light source displaying only a predetermined color is disposed at a corner of a conventional display device, thus leading to unsuccessful color mixing. In addition, due to the unsuccessful color mixing, a color stain and a dark spot occur in the corner of the conventional display device. However, in one or more exemplary embodiment, as the light source unit 450 according to the invention includes both the first light source 452 and the second light source 453 respectively disposed at opposite ends thereof (e.g., at corners of the display device), the first light source 452 collectively emitting a red light and a blue light emitting and the second light source 453 collectively emitting a green light, color mixing may be properly performed at the corner of the display device, and thus, the generation of a color stain and a dark spot may be reduced or effectively prevented at one or more corners of the display device.

In addition, as the light source 451 is disposed at each of the first and second inclination portions 454a and 454b of the circuit board 454, the number of light sources 451 is twice the number of light sources included in the conventional display device, such that the luminance of the display device may be enhanced.

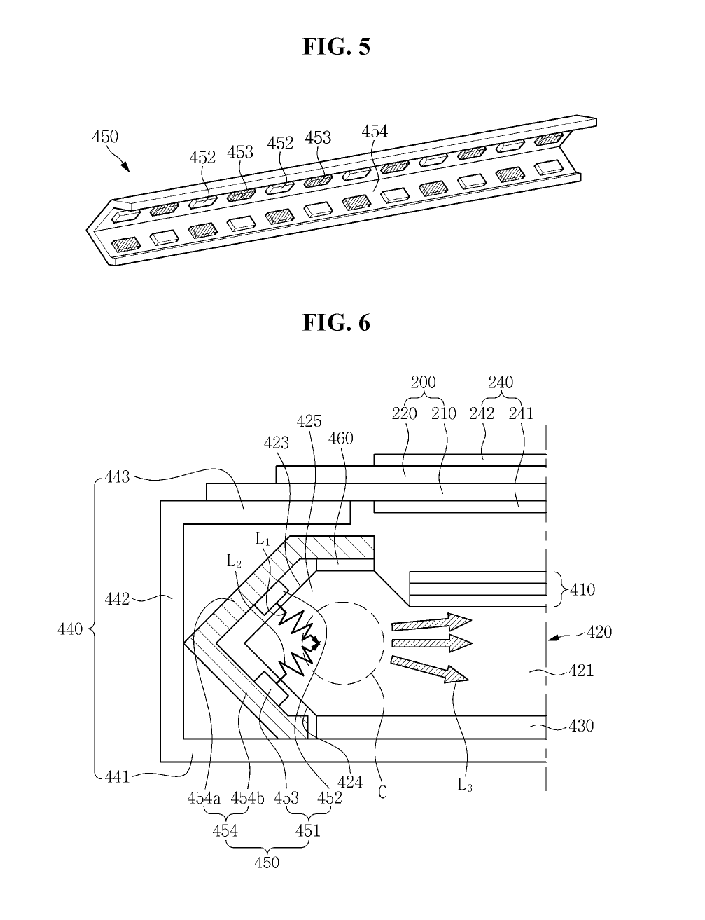

Hereinafter, other exemplary embodiments of a display device will be described with reference to FIGS. 5, 6, 7, 8 9 and 10. A description thereof that is the same as that provided in the previous exemplary embodiment will be omitted herein for conciseness.

FIG. 5 is a perspective view illustrating another exemplary embodiment of a light source unit 450 according to the invention.

Referring to FIG. 5, another exemplary embodiment of a light source 451 according to the invention includes a first light source 452 and a second light source 453 that are alternately disposed along a length direction of the circuit board 454. The first light source 452 provided in plural and the second light source 453 provided are alternately disposed, both horizontally along the length direction of the circuit board 454 and vertically in a direction perpendicular to the length direction. Where the first light source 452 and the second light source 453 are disposed in the above-described manner, the same effect as that in the previous exemplary embodiment may be achieved.

FIG. 6 is a cross-sectional view illustrating another exemplary embodiment of a display device according to the invention.

Referring to FIG. 6, another exemplary embodiment of a light mixing portion 425 is defined by first and second inclination surfaces 423 and 424, horizontal surfaces respectively extending therefrom, and a third inclination surface which connects an upper horizontal surface of the mixing portion 425 to an upper horizontal surface of the base portion 421. The upper horizontal surfaces are not coplanar with each other. The mixing portion 425 is defined by an upper surface thereof that is positioned higher than the upper surface of a base portion 421 in a thickness direction of the display device. Where the light mixing portion 425 is defined in the above-described manner, a light overlapping area C for mixing a light L1 emitted from a first light source 452 and a light L2 emitted from a second light source 453 may be expanded and high color reproducibility may be achieved.

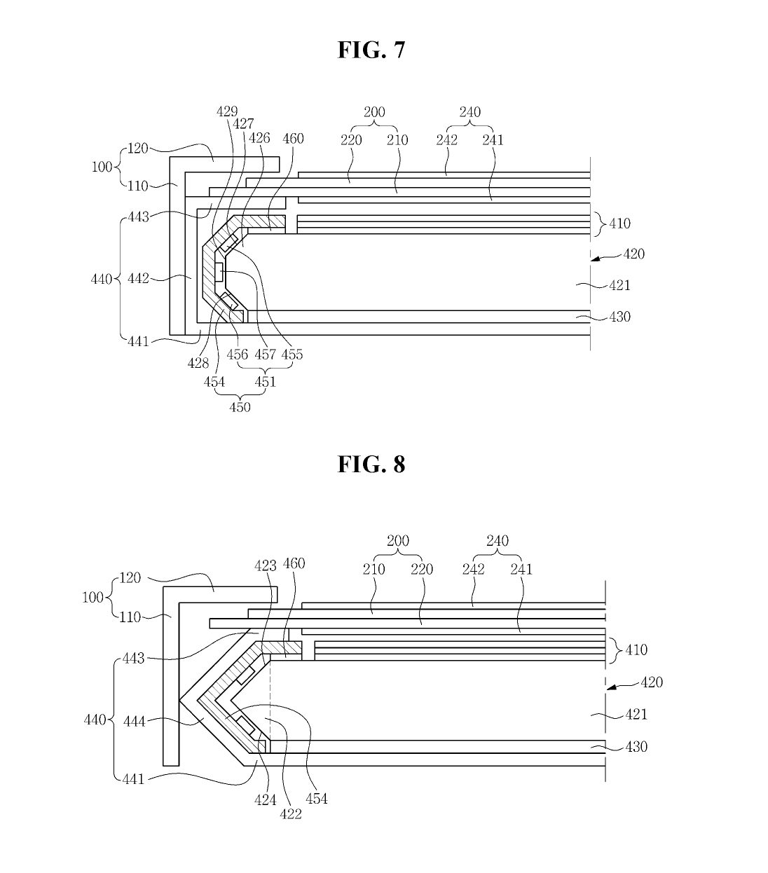

FIG. 7 is a cross-sectional view illustrating still another exemplary embodiment of a display device according to the invention.

Referring to FIG. 7, another exemplary embodiment of a light source 451 according to the invention collectively includes a first light source 455, a second light source 456 and a third light source 457, and another exemplary embodiment of a light guide plate 420 includes a first inclination surface 427, a second inclination surface 428 and a third inclination surface 429. The first, second and third inclination surfaces 427, 428 and 429 are inclined with respect to each other and are inclined at different angles with respect to the light emitting surface of the light guide plate 420. In an exemplary embodiment, for example, the first light source 455 faces the first inclination surface 427 and emits a red light. The second light source 456 faces the second inclination surface 428 and emits a green light. The third light source 457 faces the third inclination surface 429 and emits a blue light. In other words, the third light source 457 emits a light having a wavelength different from a wavelength of a light emitted from the first light source 455 and different from a wavelength of a light emitted from the second light source 456. An inner angle formed between the first inclination surface 427 and the third inclination surface 429 is an obtuse angle, and an inner angle formed between the second inclination surface 428 and the third inclination surface 429 is an obtuse angle.

A light mixing portion 426 is defined by the first, second and third inclination surfaces 427, 428 and 429 and horizontal surfaces respectively extending from the first and third inclination surfaces 427 and 428 and connected directly to upper and lower horizontal surfaces of the base portion 421. The first, second and third inclination surfaces 427, 428 and 429 may define a whole of the light incident surface of the light guide plate 420.

As the light source 451 and the light guide plate 420 are configured in the above-described manner, the light mixing portion 426 generates a white light in a manner similar to that used in the previous exemplary embodiments. In addition, the number of light sources 451 increases three times the number of light sources included in the conventional display device, such that the luminance of the display device may be enhanced.

FIG. 8 is a cross-sectional view illustrating yet another exemplary embodiment of a display device according to the invention.

Referring to FIG. 8, another exemplary embodiment of a lower frame 440 according to the invention includes a side wall portion 444 having an inclination surface. The side wall portion 444 of the lower frame 440 is bent corresponding to a bent shape of a circuit board 454, so as to stably support the bent circuit board 454. The inclination surface of the lower frame 440 may be provided in plural to define a whole of the side wall portion 444.

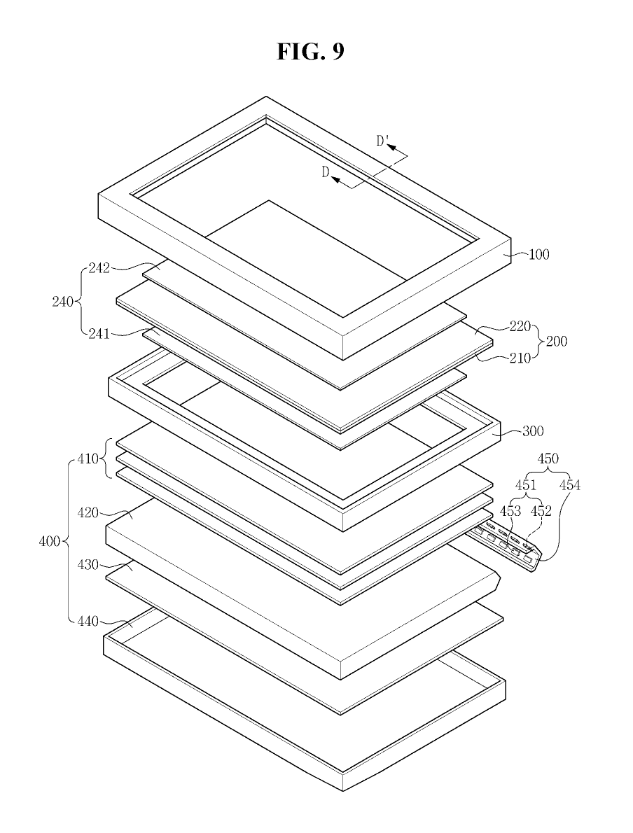

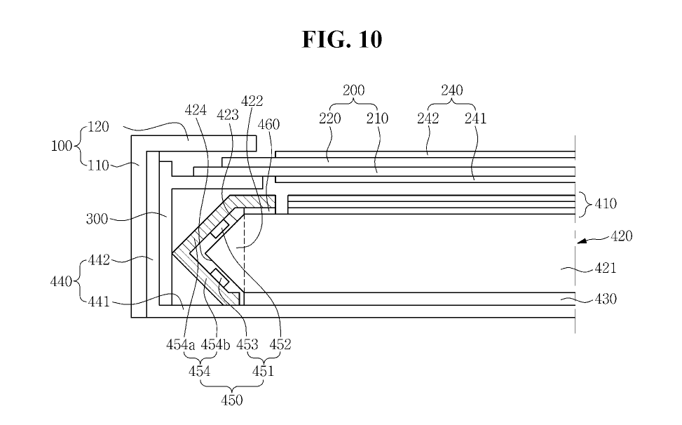

FIG. 9 is an exploded perspective view illustrating yet another exemplary embodiment of a display device according to the invention. FIG. 10 is a cross-sectional view taken along line D-D′ of FIG. 9.

Referring to FIGS. 9 and 10, another exemplary embodiment of the display device according to the invention further includes an intermediate frame 300. The intermediate frame 300 is coupled to a lower frame 440, and accommodates a display panel 200. The intermediate frame 300 may include or be formed of a flexible material such as plastic so as to reduce or effectively prevent damage to the display panel 200.

The intermediate frame 300 is provided along an edge of the display panel 200 and supports the display panel 200 from therebelow. The intermediate frame 300 may be provided corresponding to four sides or at least one of the four sides of the display panel 200. In an exemplary embodiment, for example, the intermediate frame 300 may have a quadrilateral-loop shape in the top plan view corresponding to the four sides of the display panel 200. The intermediate frame 300 may have a “[” shape, that is, a quadrilateral-open-loop shape in the top plan view, corresponding to three of the four sides of the display panel 200.

As set forth above, according to one or more exemplary embodiments, the display device may provide uniform luminance and color of light that is output from the backlight assembly. Accordingly, the display quality of the display device may be enhanced, and more particularly, a color stain or a dark spot may be reduced or effectively prevented at a corner portion of the display area of the display device. In addition, the light sources are respectively disposed on the two inclination portions of the circuit board, thus increasing a total amount of light, as compared to an amount of light achieved in the conventional display device.

From the foregoing, it will be appreciated that various embodiments in accordance with the present disclosure have been described herein for purposes of illustration, and that various modifications may be made without departing from the scope and spirit of the present teachings. Accordingly, the various embodiments disclosed herein are not intended to be limiting of the true scope and spirit of the present teachings. Various features of the above described and other embodiments can be mixed and matched in any manner, to produce further embodiments consistent with the invention.

What is claimed is:

1. A display device comprising:
a display panel which displays an image with light;
a light source which generates and emits the light, the light source comprising a first light source and a second light source which are disposed at a same side of the display panel and each generate the light; and
a light guide plate which receives the light emitted from the light source and emits the light to the display panel,
wherein
the light guide plate defines a light incident side surface thereof at the same side of the display panel at which the first and second light sources are disposed, and
the light incident side surface comprises a first inclination surface facing the first light source and a second inclination surface facing the second light source.

2. The display device of claim 1, wherein an angle formed between the first inclination surface and the second inclination surface is an acute angle.

3. The display device of claim 1, further comprising a circuit board at the light incident side surface of the light guide plate,
wherein the circuit board defines a first inclination portion thereof on which the first light source is mounted and a second inclination portion thereof on which the second light source is mounted.

4. The display device of claim 1, wherein a wavelength of the light emitted from the first light source is different from a wavelength of the light emitted from the second light source.

5. The display device of claim 4, wherein
the light guide plate further defines a base portion thereof extended to define a light mixing portion of the light guide plate at which are mixed the light emitted from the first light source and the light emitted from the second light source to thereby generate white light; and
the light mixing portion comprises the first and second inclination surfaces.

6. The display device of claim 5, wherein the light mixing portion is disposed in a non-display area of the display panel.

7. The display device of claim 5, wherein
the base portion of the light guide plate defines a light emitting surface thereof facing the display panel and through which the light is emitted to the display panel, and
an upper surface of the light mixing portion is spaced apart from the light emitting surface in a thickness direction of the light guide plate.

8. The display device of claim 1, wherein
the light source further comprises a third light source which generates and emits the light at the same side of the display panel at which the first and second light sources are disposed, and
the light incident side surface defined by the light guide plate further comprises a third inclination surface facing the third light source.

9. The display device of claim 8, wherein
an angle formed between the first inclination surface and the third inclination surface is an obtuse angle, and
an angle formed between the second inclination surface and the third inclination surface is an obtuse angle.

10. The display device of claim 8, wherein
a wavelength of the light emitted from the third light source is different from a wavelength of the light emitted from the first light source and different from a wavelength of the light emitted from the second light source, and
the light guide plate further defines a base portion thereof extended to define a light mixing portion of the light guide plate at which are mixed the light emitted from the first light source, the light emitted from the second light source, and the light emitted from the third light source to thereby generate white light.

11. A display device comprising:
a display panel which displays an image with light;
a light source which generates and emits the light, the light source comprising a first light source and a second light source which are disposed at a same side of the display panel and each generate the light, the first light source and the second light source being alternately disposed along a length of the same side of the display panel; and
a light guide plate which receives the light emitted from the light source and emits the light to the display panel,
wherein
the light guide plate defines a light incident side surface thereof at the same side of the display panel at which the first and second light sources are disposed, and
the light incident side surface comprises a first inclination surface facing the light source and a second inclination surface facing the light source.

12. The display device of claim 11, wherein an angle formed between the first inclination surface and the second inclination surface is an acute angle.

13. The display device of claim 11, further comprising a circuit board at the light incident side surface of the light guide plate,
wherein the circuit board defines:
a first inclination portion thereof on which a portion of the first and second light sources are mounted, and
a second inclination portion thereof on which a remaining portion of the first and second light sources are mounted.

14. The display device of claim 11, wherein a wavelength of the light emitted from the first light source is different from a wavelength of the light emitted from the second light source.

15. The display device of claim 14, wherein
the light guide plate further defines a base portion thereof extended to define a light mixing portion of the light guide plate at which are mixed the light emitted from the first light source and the light emitted from the second light source to thereby generate white light; and
the light mixing portion comprises the first and second inclination surfaces.

16. The display device of claim 15, wherein the light mixing portion is disposed in a non-display area of the display panel.

17. The display device of claim 15, wherein
the base portion of the light guide plate defines a light emitting surface thereof facing the display panel and through which the light is emitting to the display panel, and
an upper surface of the light mixing portion is spaced apart from the light emitting surface in a thickness direction of the light guide plate.

18. The display device of claim 11, wherein
the light source further comprises a third light source which generates and emits the light at the same side of the display panel at which the first and second light sources are disposed, and
the light incident side surface defined by the light guide plate further comprises a third inclination surface facing the third light source.

19. The display device of claim 18, wherein
an angle formed between the first inclination surface and the third inclination surface is an obtuse angle, and
an angle formed between the second inclination surface and the third inclination surface is an obtuse angle.

20. The display device of claim 18, wherein
a wavelength of the light emitted from the third light source is different from a wavelength of the light emitted from the first light source and different from a wavelength of the light emitted from the second light source, and
the light guide plate further defines a base portion thereof extended to define a light mixing portion of the light guide plate at which are mixed the light emitted from the light emitted from the first light source, the light emitted from the second light source, and the light emitted from the third light source to thereby generate white light.
